(19) United States
(12) Patent Application Publication
(10) Pub. No.: US 2003/0220969 A1
(43) Pub. Date: Nov. 27, 2003

(54) Combined interface providing method, device, and recording media

(76) Inventors: Gou Kojima, Yamato (JP); Masaya Shozui, Musashino (JP)

Correspondence Address: MATTINGLY, STANGER & MALUR, P.C., ATTORNEYS AT LAW, 1800 DIAGONAL ROAD, SUITE 370, ALEXANDRIA, VA, 22314, US

(21) Appl. No.: 10/373,047

(22) Filed: Feb. 26, 2003

(30) Foreign Application Priority Data
May 27, 2002 (JP) 2002-151721

(51) Int. Cl. G06F 15/16

(52) U.S. Cl. 709/203

(57) ABSTRACT

In order to provide a user with a combined user interface formed by merging user interfaces of applications provided by a plurality of independent servers, a device for providing a combined user interface, on receiving a request to generate a combined page from a WWW browser, starts a combined page generating object, and obtains pages as sources of a combined page from WWW servers according to information about request data allocation definition and information about data extraction definition, analyzes obtained pages, extracts data necessary to generate a combined page, generates a combined page according to information about combined page definition by using the extracted data, transmits a combined page generated to the WWW browser, and displays the page on the display.

### BACKGROUND OF THE INVENTION

The present invention relates to a method for providing a combined user interface by which to supply the user with combined data from a plurality of sources, and particularly to a suitable method for the client to use a plurality of application programs sent from multiple servers to the client over a network.

Application services using WWW as the user interface are provided across a network, such as the Internet. When a client uses WWW, the client need not have his or her own program for each application but can use all WWW-based applications if the WWW browser is available. However, in respective applications using WWW, even when processes using common data are executed in different applications, there have not been any such an arrangement for multiple users to perform respective applications by dynamic exchange of common data; therefore, each user must open another window on the WWW browser to obtain and input data for the execution of the application.

A system having a dedicated service coordination unit is disclosed in Japanese Patent Application Laid-Open No. 10-232899. In this system, the existing WWW services are used as the basic services, and virtual services are defined in advance for cooperation of a plurality of basic services, and when providing service, virtual service objects are generated in an internal device, which uses when necessary, the basis service objects according to the above-mentioned definitions. Subsequently, the system performs a virtual service in the form of execution of the generated virtual service objects in the same manner as in the execution of a single basic service.

When the service cooperation device is provided, it is possible to provide the user with service as if the user were receiving a single service even though he or she is receiving service as a result of integration of a plurality of services. However, this system is capable of outputting an image composed of whole screen images or parts of the images provided by basic services and made up a combination of them. However, the system cannot extract only common items of data from a plurality of applications to merge them into an image of such a structure that the user can use more easily, nor can it extract only necessary items of data to provide a user interface image in a new layout as a combined user interface by data extracted from multiple WWW pages.

### SUMMARY OF THE INVENTION

The present invention has been made to solve this problem, and has as its object to provide a technology for extracting desired items of data from a plurality of applications, and providing the user with a WWW page on which the extracted data items are laid out. A page formed by a plurality of WWW service pages and shown in a browser window is referred to as a combined page in the following description.

To achieve the above object, the method for providing a combined user interface according to the present invention comprises analyzing WWW service pages provided by a plurality of existing WWW services that deal with common data items, extracting desired items of data from WWW pages, and generating a page by extracted data and displaying the page in a window of the WWW browser.

More specifically, a method for the method for providing a combined user interface comprises the steps of accessing a WWW server that provides existing WWW services defined as sources for a combined page, obtaining WWW pages, analyzing the obtained pages by a previously defined procedure, extracting data in a structured data format, and generating a combined page by a previously defined procedure for outputting combined data by using extracted data.

When generating a combined page, if there is data of common items among a plurality of object pages, it is effective to output a table of information merged by using common items as keys on a combined page to provide ease of use for the user.

According to the present invention, since data on pages of existing WWW services can be extracted as data for a combined page, it is possible to provide a combined page in a flexible layout not limited by the layout of existing WWW pages.

According to this method, a plurality of pages can be used to generate a combined page. If there are common data items among the pages when generating a combined page, it is possible to display a table of merged data by using common items as a key, which makes it possible to provide a more user-friendly combined page.

Further, since data can be extracted in an elaborate manner from pages as source for a combined page and a combined page can be generated from meticulously extracted data, a combined page can be generated in a flexible layout without being regulated by the layout of the existing WWW pages, so that it is possible to provide a combined page with visual convenience.

Other objects, features and advantages of the invention will become apparent from the following description of the embodiments of the invention taken in conjunction with the accompanying drawings.

### BRIEF DESCRIPTION OF THE DRAWINGS

FIG. 1 is a function block diagram of a system for providing a combined user interface.

FIG. 2 is a detailed block diagram of a combined user interface providing device.

FIG. 3 shows an order confirmation service page provided by a WWW server 31.

FIG. 4 shows an inventory allocation service page provided by a WWW server 32.

FIG. 5 shows data extraction definition information from an order confirmation service page.

FIG. 6 shows data extraction definition information from an inventory allocation service page.

FIG. 7 shows a data structure extracted from the order confirmation service page.

FIG. 8 shows a data structure extracted from the inventory allocation service page.

FIG. 9 shows request data allocation definition information.

FIG. 10 shows combined page definition information.

FIG. 11 is a flowchart showing a process for providing a combined page.

FIG. 12 shows an example of a combined page.

### DETAILED DESCRIPTION OF EMBODIMENT

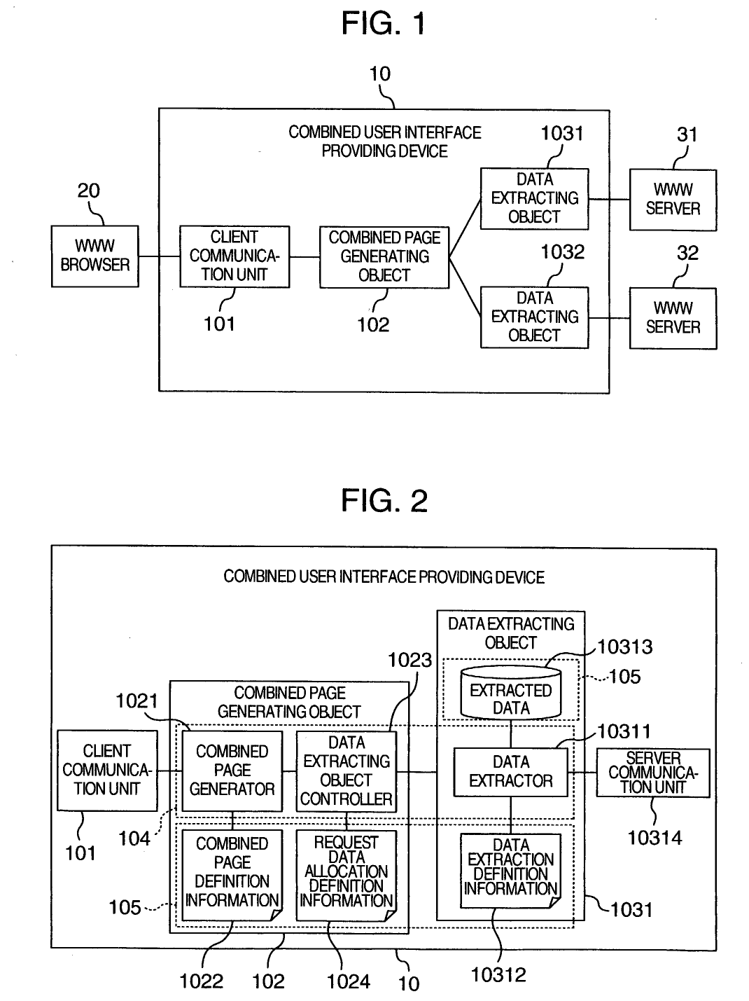

A first embodiment of the present invention will be described with reference to the accompanying drawings. FIG. 1 is a block diagram showing a functional composition according to the present invention, in which 10 denotes a device for providing combined user interface. This device analyzes a user interface (page) supplied by a plurality of WWW servers in response to a request from a WWW browser of a client, extracts necessary data, generates a combined user interface (a combined page) formed by re-layout by using the extracted data, and transmits the page to the WWW browser of the request-originating client.

Reference numerals 31 and 32 denote WWW servers that provide application services (interfaces) on WWW pages. Reference numeral 20 denotes a client's WWW browser using WWW-based services. In this embodiment, the client uses combined WWW service (a combined user interface) sent from the combined user interface providing device.

The combined user interface providing device 10 includes a client communication unit 101 for sending a generated combined page to the WWW browser 20 in response to a request to generate a combined page from the WWW browser 20, a combined page generating object 102 for generating a combined page to comply with the request from the WWW browser 20 and sending the generated combined page to the WWW browser, and one or more data extracting objects 1031, 1032 for, in response to a request from the combined page generating object 102, accessing the existing WWW servers 31 and 32, receiving a page, analyzing the obtained page, and extracting necessary information.

FIG. 2 shows in a concrete form the structure of the combined page generating object 102 and the data extracting object 1031. The combined page generating object 102 includes a combined page definition information 1022 having defined therein a combined page layout method to generate, a combined page generator 1021 for generating a combined page by referring to the combined page definition information 1022 and by using data extracted by the data extracting object 1031, request data allocation definition information 1024 having defined therein allocation types to the respective data extracting objects, and a data extracting object controller 1032 for referring to the request data allocation definition information 1024, allocating request data to each of the data extracting objects 1031, 1032, and controlling the extraction action of the data extracting objects and the reference action to extracted data.

The combined user interface providing device 10 includes a server communication unit 10314 for accessing the WWW server 31 to obtain a HTML page. The data extracting object 1031 includes a data extractor 10311 for extracting data necessary for analyzing HTML pages obtained through the server communication unit 10314 and generating a combined page; data extraction definition information 10312; and extracted data 10313. The data extractor 10311 extracts data by a method for analyzing obtained WWW pages, which has been described in the previously defined data extraction definition information 10312, and stores data in the extracted data 10313.

The data extracting object controller 1023 and the data extractor 10311 perform their functions when their respective modularized programs are executed by a processor. When those programs are traded, they are normally stored in recording media readable by an information processor, such as CD-ROMs, not shown. The programs are read from a medium by a medium reader (not shown), stored in a memory device, such as HDD, and installed in the combined user interface providing device 10. When the processor sequentially reads programs from the memory device and executes the programs, the data extracting object controller 1023 and the data extractor 10311 perform their functions. The dotted line 104 indicates a program for reading and executing the programs. The combined page definition information 1022, the request data allocation definition information 1024, and the data extraction definition information are stored in the memory device as with the programs mentioned above. The dotted line 105 indicates memory devices for storing those items of information and extracted data.

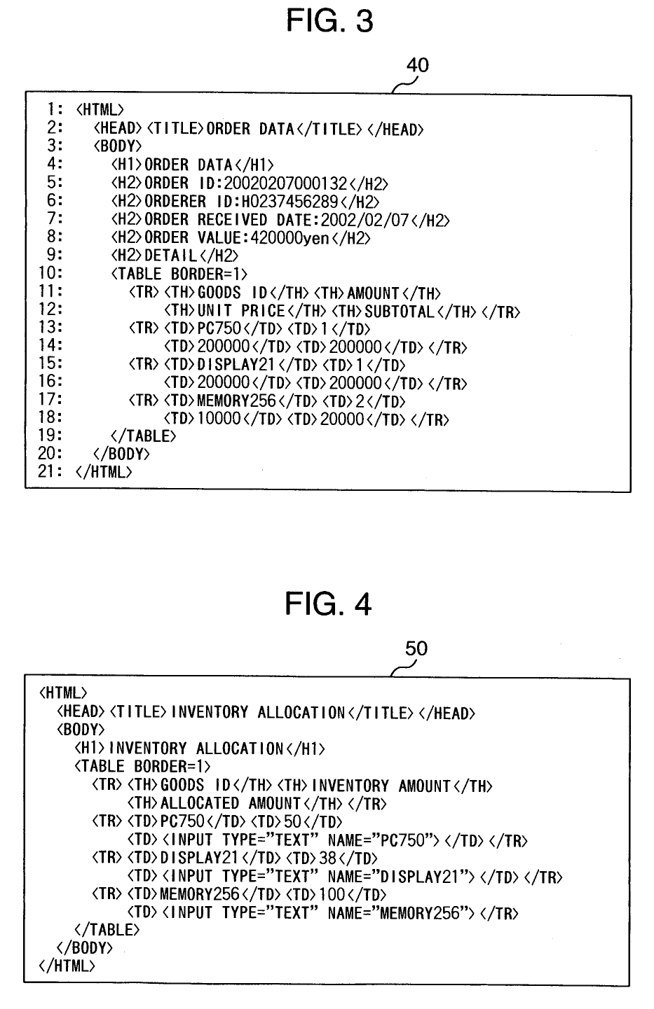

FIG. 3 shows an HTML source 40 on a page of order confirmation service provided by the WWW server 31. The WWW server 31 is a service system for business firms, and therefore provides service for users in a firm to confirm information about orders from the customers, in other words, when they confirm order information for their own firm.

FIG. 4 shows an HTML source 50 on a page of order confirmation service provided by the WWW server 32. The WWW server 32 is a service system in a firm, and provides in-house service for users in the firm when they confirm inventory and do allocation job.

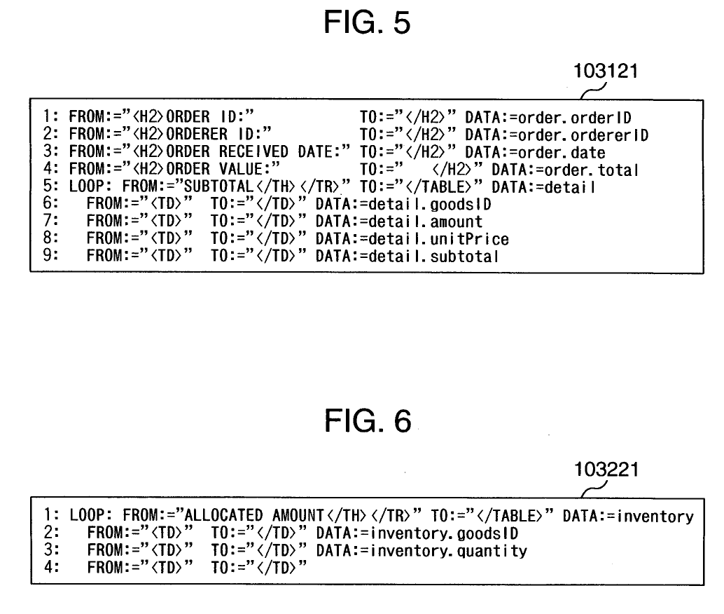

FIG. 5 shows an example 103121 of data extraction definition information 10312 which is referenced by the data extractor 10311 of the data extracting object 1031 that accesses order confirmation service provided by the WWW server 31, analyzes the HTML source 40 of an obtained page, and extracts data.

FIG. 6 shows an example 103221 of data extraction definition information which is referenced by the data extractor of the data extracting object 1032 that accesses inventory allocation service provided by the WWW server 32, analyzes the HTML source 50 of an obtained page, and extracts data.

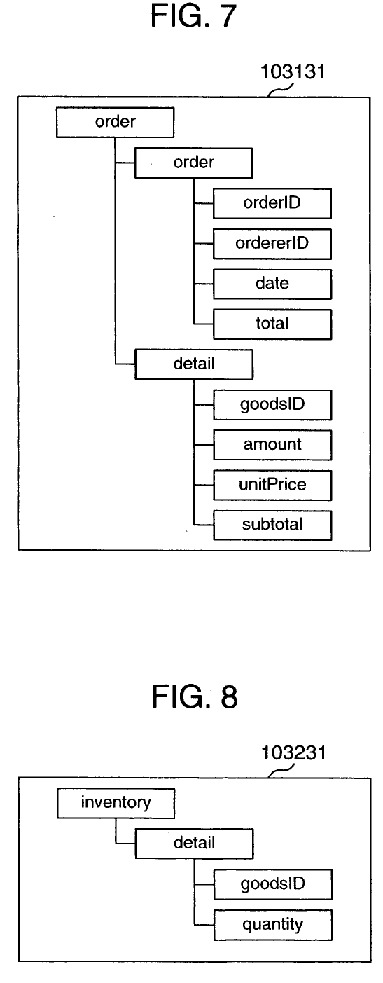

FIG. 7 shows one structure 103131 of extracted data 10313 held in the data extracting object 1031 that accesses order confirmation service defined in the data extraction definition information 103121.

FIG. 8 shows one structure 103231 of extracted data held in the data extracting object 1032 that accesses inventory allocation service defined in the data extraction definition information 103221.

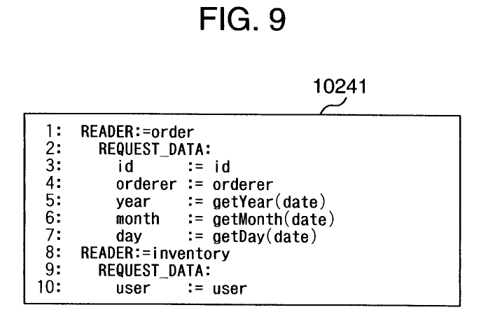

FIG. 9 shows an example 10241 of the request data allocation definition information 1024 which is referenced by the data extracting object controller 1023 in the combined page generating object 102 when the controller 1023 converts request data from the WWW browser 20, received through the client communication unit 101.

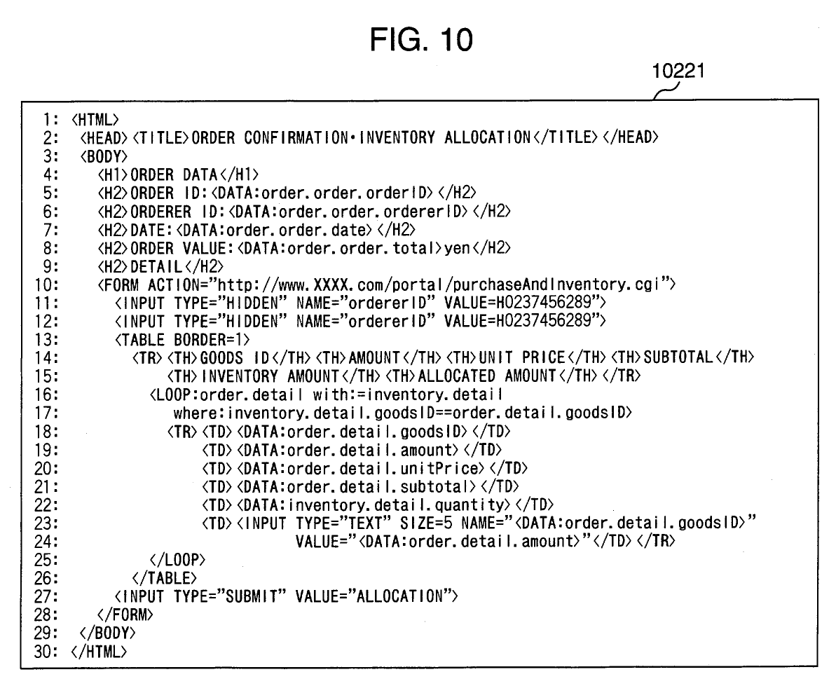

FIG. 10 shows an example 10221 of combined page definition information 1022 which is referenced by the combined page generator 1021 of the combined page generating object 102 when the combined page generator 1021 generates a combined page by using extracted data 10313 extracted by the data extracting objects 1031, 1032.

In this embodiment, the combined user interface providing device 10 displays a combined page that joins together a page of order confirmation service provided by the WWW server 31 and a page of inventory allocation service provided by the WWW server 32, and also provides an order confirmation-inventory allocation page which makes it possible to carry out on a single page the two services of order confirmation and inventory allocation by merging information about the two services by using a goods ID on the order confirmation service page and a goods ID on the inventory allocation service page as the key.

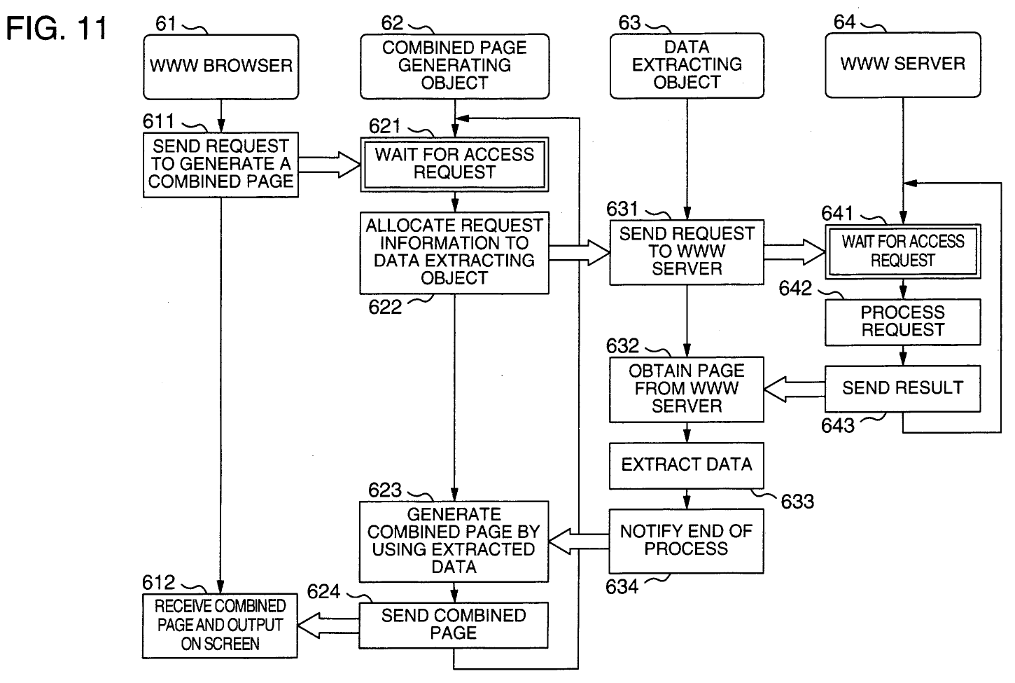

FIG. 11 is a flowchart of a whole process when the WWW browser 20 accesses the combined user interface providing device 10 to use a combined page. Reference numeral 61 indicates the flow of the process of the WWW browser 20, 62 indicates the flow of the process of the combined page generating object 102, 63 indicates the flow of the process of the data extracting objects 1031, 1032, and 64 indicates the flow of the WWW servers 31, 32.

In response to a designated URL or an instruction from a user, such as a click on a link on a displayed page, the WWW browser 20 transmits a request to generate a combined page to the combined user interface providing device 10 (to its client communication unit 101) (Step 611). More specifically, a request to generate a combined page includes a URL for a combined page generated by the combined user interface providing device or form data input in a form on the page, and this request is sent by HTTP communication.

The client communication unit 101 of the combined user interface providing device 10, on receiving a request from the WWW browser 20 (Step 621), analyzes the request, selects a combined page generating object 102 that generates a combined page to meet the request, and asks the combined page generator 1021 of the selected combined page generating object to generate a combined page. The combined page generating object 102 can be mounted as a Servlet object or a JSP page of Java (“Java” is a trademark of Sun Microsystems), for example. In this case, the Servlet container that manages the execution of a Servlet works as the client communication unit 101, and the request to generate a combined page is expressed by a URL for a Servlet that generates a combined page, and the Servlet container starts a relevant Servlet.

The combined page generator 1021 of the combined page generating object 102, on receiving a request to generate a combined page, receives request data from the client communication unit 101 and passes the request data to the data extracting object controller 1023. The data extracting object controller 1023 allocates the request data to the data extracting objects 1031, 1032 according to the request data allotting definition information 1024 (Step 622).

In an example of the information about request data allocation definition in FIG. 9, a method for allocating request data to the data extracting object 1031 named “order” is defined from the first line to the seventh line. A WWW server to access is related to the user's request and is stored. A plurality of WWW servers may be selected if necessary. In the example in FIG. 9, the data extracting object 1031 named “order” here has a role to access the WWW server 31 that provides order confirmation service. It is assumed that the order confirmation service here makes it possible to obtain information about a desired order by transmitting request data including goods ID, orderer ID, and date.

From the third line to the seventh line, a specific method for allocating data is defined. The left side of “:=” shows request data when the data extracting object accesses a WWW server, and the right side shows request data sent from the WWW browser 20 to the combined user interface providing device 10 and also shows a method for converting the request data. For example, the third line shows that request data “id” from the WWW browser 31 is sent directly as request data “id” to the WWW server. The fifth line means that request data “date” from the WWW browser 20 is passed to a function “getYear”, and year information in date information returned as a result is sent as request data “year” to the WWW server. The eighth line to the tenth line show in like manner a method for allocating request data to a data extracting object named “inventory”.

The data extracting object 1031, to which request data has been allocated, accesses a WWW server 31 that provides data to extract and sends the allocated request data to the server, and obtains a page from the WWW server 31 (Steps 641, 642, 643 and 632).

Then, the data extractor 10311 of the data extracting object 1031 analyzes the obtained page and extracts data necessary to generate a combined page according to the data extraction definition information 10312 (Step 633). A specific method for extracting data in the data extractor 1031 of the data extracting object 1031 to access the WWW server that provides order confirmation service and extract data from an order conformation page will be described referring to HTML 40 of the order confirmation page in FIG. 3 and an example 10321 of the data extraction definition information for the order confirmation page in FIG. 5.

The example 10312 of the data extraction definition defines a procedure of tracking the obtained page by moving the cursor in a manner to follow the character strings from the beginning, and reading character strings enclosed by the character strings specified in the definition is read from the page, and extracting data of a structure shown in FIG. 7. The define statement on the first line means to extract the character string enclosed by “<H2>order ID:” and “</H2>” as a data item ordererID under the order layer and the portion on the fifth line of HTML source on the order confirmation page corresponds to that definition, so that a character string “20020207000132” can be extracted. By carrying out the same process on the lines as far as the fourth line, a character string “H0237456289” can be extracted as the data item of the ordererID, a character string “2002/02/07” as the data item of date, and then a character string “420000” as the data item of total.

The portion from the fifth line down defines a method for extracting data items that recur. More specifically, what is defined here is that the data extracting process is carried out on the character string between “sub-total</TH></TR>” and “</TABLE>” as shown on the fifth line and this process is repeated for the sixth line till the ninth line. It is also shown that a data layer named “detail” is newly generated on each repetition. The portion from the 13th line to the 18th line of the HTML source 40 of the order confirmation page defines that repetition. The 13th and 14th lines constitute the first unit of repetition, and as for the data items of the first detail layer, “PC750” is extracted as “goods ID”, “1” is extracted as “amount”, “200000”, is extracted as “unitPrice”, and 200000 is extracted as “subtotal”.

The data extractor 10311, after having extracted data from the obtained page in the manner described, notifies to the data extracting object controller 1023 of the data extracting object 102 that the data extracting process has been completed (Step 634).

After having been notified that the process of extracting data necessary to generate a combined page was completed, the data extracting object controller 1023 requests the combined page generator 1021 to generate a combined page. The combined page generator 1021 generates a combined page according to the combined page definition information 1022 by using data extracted by each data extracting object (Step 623). A method for generating a combined page of order confirmation and inventory allocation, which integrates an order confirmation page and an inventory allocation page, will be described by referring to an example 10221 of combined page definition information in FIG. 10.

In the example 10221 of the combined page definition information 1022, a method for generating a combined page is defined in a format including specific tags, such as “LOOP:” and “DATA:” shown from the fifth line to the eighth line and the 16th line to 24th line in a text in usual HTML format. The combined page generator 1021 outputs the portions other than the specific tags of a combined page as they are in a combined page in the example 10221 of the combined page definition information.

The “DATA:” tag on the fifth line means that data of the orderID of the order layer extracted by the data extracting object named “order” is output in that portion of the page which is specified by the tag. The “DATA:” tag shows that extracted data by the specified data extracting object is output at the position of this tag in a manner to replace the tag.

The “LOOP:” tag on the 16th line designates an output process of a data item that recurs and specifies that the output process shown on the 18th line to the 24th line repeats. The number of the data layer of the data extracting object named “order” indicates the number of times of repeat process. In this repeat process, in the detail layers of extracted data of the “inventory” data extracting objects, a detail layer including a key goods ID is specified. The detail layer including the key goods ID is also specified in the extracted data of the “order” data extracting object. The both detail layers having the same goods ID are merged and the merged layers are used when outputting quantity data of the detail layer of the inventory data extracting object on the 22nd line.

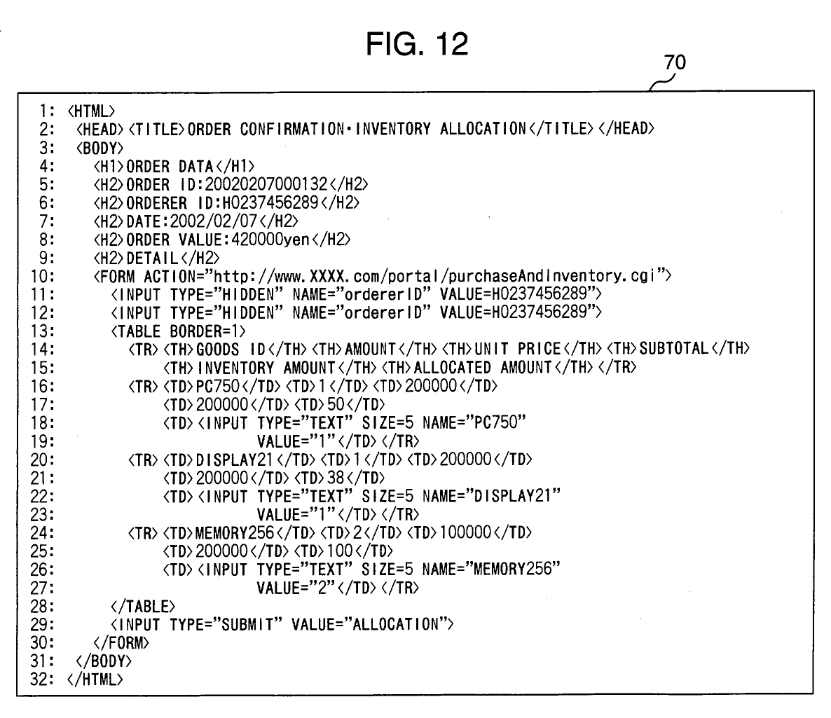

By performing the output process of a combined page described above, as shown in FIG. 12, a combined page 70 can be generated by merging tables of the two services using a goods ID on an order confirmation page and a goods ID on an inventory allocation page as the key.

The combined page generator 1021, after completing the combined page generating process, passes a generated combined page to the client communication unit 101 to send the combined page to the WWW browser 20 as the source of request to generate a combined page (Step 624).

The WWW browser 20 receives a combined page (its HTML source) from the device for combined user interface and outputs a combined page (Step 612).

According to the above-mentioned embodiment, it is possible to a combined page organized by a selected number of data items by merging pages supplied by a plurality of existing WWW services without directly tampering with the existing WWW servers. For example, as has been described referring to the above-mentioned embodiment, tables from a plurality of pages can be merged by using specific data items as keys to generate a combined page.

In the above-mentioned embodiment, it was assumed that the device for a combined user interface is on a computer external to the WWW browser and that the client communicates with servers by HTTP communication. However, it is possible to mount the combined user interface providing device in a computer in which the client's WWW browser has been installed. For example, the combined user interface providing device may be manufactured in the form of an incorporable unit as an additional function to the WWW browser, and it is possible to establish communication between the WWW browser and the user interface device by interprocess communication or by function call instead of HTTP communication, thereby reducing process load on the client communication unit 101, and improving the total process speed in generating a combined page.

In the above-mentioned embodiment, the combined page definition information 1022, the request data allocation definition information 1024, and the data extraction definition information 10312 are all provided as definition files in text format, but they may be installed as programs, and the execution of programs makes process speed faster than by executing processes by reading definition information.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method for coupling a client with a plurality of servers, obtaining user interfaces provided by said servers, and providing said client with a combined user interface, comprising the steps of:
in response to a request from said client, allocating request information sent from said client to said plurality of servers to ask for a user interface;
extracting data on data items, necessary to form said combined user interface, from user interfaces sent from said servers;
generating said combined user interface from said extracted data; and
sending said combined user interface to said client.

2. A method for providing a combined user interface according to claim 1, further comprising the step of:
holding information about request information allocation definition showing a method for allocating request information sent from said client to said plurality of servers, extraction definition information for extracting necessary data items from information of user interfaces obtained by assessing said plurality of servers, and information about user interface combining definition showing a method for generating a combined user interface by merging a plurality of user interfaces by using necessary data extracted from said user interfaces,
wherein a process for requesting said plurality of servers to provide user interfaces is executed based on said information about request information allocation definition, a process for extracting said necessary data items is executed based on said extraction definition information, and a process for generating said combined user interface is executed based on said information about user interface combining definition.

3. A method for providing a combined user interface according to claim 2, wherein said information about request information allocation definition includes definition for specification of a server to access according to request information from said client, and a definition of a method for converting request information from said client into request information to said server.

4. A method for providing a combined user interface according to claim 2, wherein said extraction definition information includes a definition of a method for extracting recurring data items.

5. A method for providing a combined user interface according to claim 2, wherein said information about user interface combining definition includes definition information for replacing a specified interface definition description with said extracted data.

6. A method for providing a combined user interface according to claim 1, wherein said process for generating a combined user interface is to generate a combined user interface by merging related data extracted from interfaces by using data items common to the interfaces of said plurality of servers as keys.

7. A method for providing a combined user interface according to claim 1, wherein said process for generating a combined user interface embeds said extracted data in a prepared combined user interface to generate a combined user interface.

8. A combined user interface providing device for providing the user with a combined user interface by coupling a client with a plurality of servers and obtaining user interfaces provided by said servers, comprising:
means, in response to a request from said client, for allocating request information sent from said client to said plurality of servers to ask for supply of user interfaces;
means for extracting data of items necessary to form a combined user interface from said user interfaces sent from said servers;
means for generating said combined user interface by using said extracted data; and
means for sending said combined user interface to said client.

9. A combined user interface providing device according to claim 8, further comprising means for holding information about request information allocation definition showing a method for allocating request information sent from said client to said plurality of servers, extraction definition information for extracting necessary data items from obtained from information of user interfaces obtained by accessing said plurality of servers, and information about user interface combining definition showing a method for generating a combined user interface by merging a plurality of user interfaces by using necessary data extracted from said user interfaces,
wherein said requesting means executes a requesting process based on said information about said request information allocation definition, said extracting means executes extraction of necessary data based on said extraction definition information, and said generating means executes a process generating a combined user interface based on said information about user interface combining definition.

10. A recording medium readable by an information processor containing a program providing a user interface for obtaining a user interface provided by a server and providing the client with a combined user interface, wherein said program comprises the codes for executing the steps of:
in response to a request from said client, allocating request information sent from said client to said plurality of servers to request supply of user interfaces;
extracting data on data items necessary to form said combined user interface from said user interfaces sent from said servers;
generating said combined user interface by using said extracted data; and
sending said combined user interface to said client.

11. A recording medium for storing said program for providing a user interface in claim 10, wherein said program further comprises the codes executing the step of holding information about request information allocation definition showing a method for allocating request information sent from said client to said plurality of servers, extraction definition information for extracting necessary data items from obtained from information of user interfaces obtained by accessing said plurality of servers, and information about user interface combining definition showing a method for generating a combined user interface by merging a plurality of user interfaces by using necessary data extracted from said user interfaces,
wherein said step of requesting said plurality of servers to supply user interfaces is executed based on said information about request information allocating definition, and said step of extracting said necessary data items is executed based on said extraction definition information, and said step of generating said combined user interface is executed based on said information about user interface combining definition.
